(19) United States
(12) Patent Application Publication
(10) Pub. No.: US 2024/0240719 A1
(43) Pub. Date: Jul. 18, 2024

(54) Slide Unit For A Shut-Off Valve

(71) Applicant: Georg Fischer Rohrleitungssysteme AG, Schaffhausen (CH)

(72) Inventors: Oliver Trefz, Bonndorf (DE); Martin Andry, Ftan (CH); Joerg Hunnekuhl, Jestetten (DE); Christoph Krauter, Gottmadingen (DE); Jonas Huessy, Neunkirch (CH)

(21) Appl. No.: 18/402,904

(22) Filed: Jan. 3, 2024

(30) Foreign Application Priority Data
Jan. 13, 2023 (EP) 23 151 434.0

(51) Int. Cl. F16K 3/02

(52) U.S. Cl. CPC F16K 3/0227; F16K 3/0281

(57) ABSTRACT

Slide unit for a shut-off valve, preferably a gate valve, comprising a shut-off wedge for closing and opening the shut-off valve and a drive unit having a threaded connection for actuating the shut-off wedge, wherein the slide unit has a sealed chamber, wherein the threaded connection of the drive unit is arranged in the sealed chamber and a sealing unit is provided for sealing the chamber, as a result of which the entire threaded connection is constantly protected against the medium and contaminants, both when the shut-off valve is open and closed.

### CROSS-REFERENCE TO RELATED APPLICATIONS

This application claims the benefit and priority of European Patent Patent Application No. 23 151 434.0 filed Jan. 13, 2023. The entire disclosure of the above application is incorporated herein by reference.

### BACKGROUND OF THE INVENTION

### Technical Field

The invention relates to a slide unit for a shut-off valve, preferably a gate valve, comprising a shut-off wedge for closing and opening the shut-off valve and a drive unit having a threaded connection for actuating the shut-off wedge.

### Discussion

Shut-off valves of this type are generally used in supply conduits serving for transporting liquid or gaseous media. The slide unit of such a shut-off valve, preferably a gate valve, is oriented perpendicularly to the pipeline or on the centre axis thereof and can also be displaced perpendicularly thereto in order to open or to close the shut-off valve. For the displacement or actuation of the shut-off wedge from the open position into the closed position or vice versa, the slide valve has a drive axle which is generally in the form of a threaded spindle with a threaded nut. Experience has shown that, in the case of such, generally metallic shut-off valves, the threaded spindle and the threaded nut are arranged in the housing or in the slide space of the housing of the shut-off valve in contact with the medium. That is to say, the medium which flows through the shut-off valve can also enter the region above the shut-off wedge, through which region the threaded spindle also runs. As a result, the spindle and the nut become rapidly soiled and, because of the also rarely occurring actuation, have a tendency to stick, and therefore high torques have to be applied in order to move the threaded spindle and the nut.

EP 2 345 831 A1 discloses a shut-off element of a shut-off valve, in which the drive spindle is arranged in the slide chamber of the shut-off valve housing. Medium and dirt enter the slide chamber via the upper region of the shut-off element, which is hardly sealed in relation to the housing, and accumulate on the threaded spindle, which makes actuation difficult.

It is an aspect of the invention to propose a slide unit in which neither the medium nor dirt can pass onto the threaded connection of the drive unit.

### SUMMARY

This aspect is achieved in that the slide unit has a sealed chamber, wherein the threaded connection of the drive unit is arranged in the sealed chamber and a sealing unit is provided for sealing the chamber, as a result of which the entire threaded connection is constantly protected against the medium and contaminants, both when the shut-off valve is open and closed.

The slide unit according to the preferred embodiment of the invention for a shut-off valve, preferably a gate valve, comprises a shut-off wedge for closing and opening the shut-off valve and a drive unit having a threaded connection for actuating the shut-off wedge. The shut-off wedge is preferably formed from plastic or a composite material. The slide unit is arranged in a shut-off valve housing or gate valve housing, preferably made of plastic or a composite material. In order to open and close the shut-off valve, the shut-off wedge is displaced perpendicularly to the throughflow direction of the medium in the valve or to the pipeline in which the valve is installed. The drive unit has a threaded connection by means of which the shut-off wedge is displaced vertically. The shut-off wedge is preferably guided in a manner secured against torsion via its end faces in the housing. The drive axle of the drive unit is preferably formed in a manner such that it does not move upwards, and therefore the axle is not displaced vertically in the housing.

The slide unit has a sealed chamber, with the threaded connection of the drive unit being arranged in the sealed chamber, as a result of which the medium or dirt is prevented from passing onto the threaded connection and the thread thus does not stick. The sealed chamber arranged in the slide unit surrounds the threaded connection of the drive unit. A sealing unit is provided for sealing the chamber, as a result of which the entire threaded connection is constantly protected against the medium and contaminants, both when the shut-off valve is open and closed. It is advantageous if the engaged threaded connection extends only over a short portion, preferably 1 to 4 times the threaded diameter, and the threaded nut is mounted in a floating manner, as a result of which the shut-off wedge is provided with a certain degree of freedom or a relative movement between shut-off wedge and drive axle, and said shut-off wedge aligns itself in the housing or in the sealing seat when the valve is closed, and the valve is optimally closed and leakproof. So that the tightness is nevertheless ensured, the sealing unit is preferably also arranged in a floating manner, as a result of which it likewise permits and absorbs a certain relative movement.

The slide unit has a sealed chamber. The chamber preferably forms a closed region or space, through which the drive axle of the drive unit protrudes via an opening and which is closed in a medium-tight manner by the sealing unit.

It has been shown to be advantageous if the sealed chamber is at least partially formed by a cavity extending in the shut-off wedge coaxially with respect to the drive axle, preferably a bore. This makes possible a drive unit, which does not move upwards, with the shut-off wedge being displaced vertically or perpendicularly to the pipeline.

Preferably, the cavity in the shut-off wedge is closed downwards, or does not run all the way through the latter or is in the form of a blind hole, which should also be understood as meaning a threaded blind hole. This ensures a sealed chamber since there is exclusively a sealed opening through which the drive axle enters and ensures a connection to the shut-off wedge.

It has been shown to be advantageous if the sealed chamber is sealed by means of the sealing unit and the sealing unit is arranged in a floating manner. As already mentioned above, the sealing unit permits sealed access to the chamber. It has been shown to be advantageous if the sealing unit is constructed in multiple parts, preferably in two parts, since there is more tolerance in the sealing unit and, as a result, the tightness is nevertheless ensured during a tilting movement of the shut-off wedge. The sealing unit preferably comprises a scraper and a seal, preferably a shaft sealing ring, thus preventing dirt or portions of the medium from entering the chamber during the displacement of the shut-off wedge.

It is advantageous if the sealing unit is arranged and fixed at the upper end of the shut-off wedge and the sealing unit is displaced as the shut-off wedge is displaced.

Preferably, the drive unit has a drive axle, upon the actuation of which the shut-off wedge moves upwards or downwards in order to open or close the shut-off valve. The drive axle is preferably arranged in a manner such that it does not move upwards in the housing.

It has been shown to be a preferred embodiment if the threaded connection is formed by an internal thread in the cavity or bore of the shut-off wedge and an external thread on the drive axle or an internal thread in the drive axle and an external thread in the cavity of the shut-off wedge.

This arrangement permits a functional and compact design despite the additional chamber in the slide unit, such that the threaded connection is protected.

It has also been shown to be advantageous if the sealed chamber is formed by a longitudinally extending cavity arranged in the shut-off wedge, preferably a bore. The cavity preferably runs coaxially with respect to the drive axle and does not run all the way through it, but rather is closed towards the lower end of the shut-off wedge.

Preferably, the sealing unit is arranged in a displaceable or floating manner on the drive axle.

Alternatively, there is the option of arranging a protective sleeve around the drive axle. The protective sleeve can preferably be in the form of a rigid tube, but a telescopic tube or a bellows-like sleeve which protects the drive axle would also be conceivable.

It has been shown to be advantageous if the sealing unit is arranged displaceably on the protective sleeve. The protective sleeve preferably extends along the slide space in the valve housing around the drive axle, which is in the form of a drive spindle. When the shut-off valve is opened, the shut-off wedge is displaced upwards and the protective sleeve then enters the groove provided in the shut-off wedge. The protective sleeve is recessed in the shut-off wedge.

All of the configuration options can be freely combined with one another.

### BRIEF DESCRIPTION OF THE DRAWINGS

Three exemplary embodiments of the invention will be described with reference to the figures, the invention not being limited to just these exemplary embodiments. In the figures:

FIG. 1 shows a sectional view of a slide unit according to the invention in a shut-off valve in a closed position in which the threaded connection extends in the shut-off wedge,

FIG. 2 shows a sectional view of a slide unit according to the invention in a shut-off valve in an open position in which the threaded connection extends in the shut-off wedge,

FIG. 3 shows a sectional view of a slide unit according to the invention in a shut-off valve in a closed position in which the threaded connection is formed in the shut-off wedge with the aid of a threaded insert,

FIG. 4 shows a sectional view of a slide unit according to the invention in a shut-off valve in an open position in which the threaded connection is formed in the shut-off wedge with the aid of a threaded insert,

FIG. 5 shows a sectional view of a slide unit according to the invention in a shut-off valve in a closed position in which the threaded connection is formed in the shut-off wedge with the aid of a threaded bolt, and

FIG. 6 shows a sectional view of a slide unit according to the invention in a shut-off valve in an open position in which the threaded connection is formed in the shut-off wedge with the aid of a threaded bolt.

### DESCRIPTION OF THE PREFERRED EMBODIMENTS OF THE INVENTION

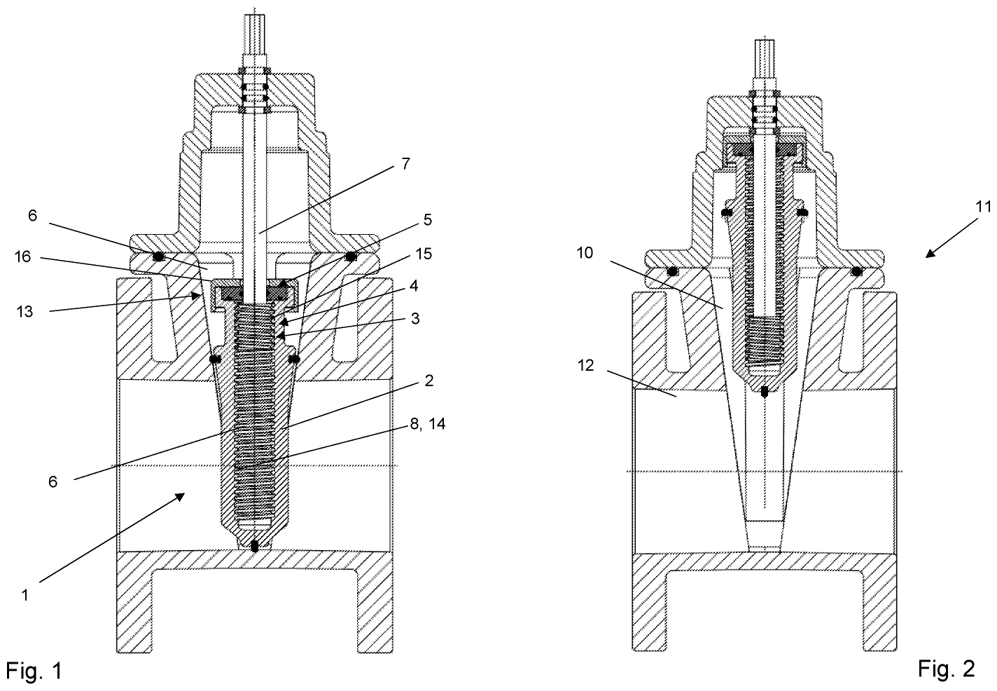

In all of the embodiments, the slide unit 1 for a shut-off valve 11 comprises a shut-off wedge 2 which is actuable by a drive unit 3, thereby allowing the shut-off valve 11 to be opened and closed. The drive unit 3 of the slide unit 1 has a threaded connection 4 by means of which the shut-off wedge 2 is adjustable. In the case of such a valve, it is customary for medium and dirt to appear in the slide space 10 of the valve housing 12 and this has previously soiled the threaded connections in such a manner that the slide units 1 have been actuable only with a very high torque. In order now to avoid such contaminations, the slide unit 1 according to the invention has a sealed chamber 6, which can be gathered from FIGS. 1 to 6 and all of the embodiments. The threaded connection 4 is arranged in this sealed chamber 6. It is advantageous if the entire threaded connection 4 is arranged in the chamber 6, with both the entire internal thread and external thread thereby being protected. In order to seal the chamber 6, a sealing unit 5 is arranged in the transition region 13, i.e. between the elements which are adjustable in the vertical direction or perpendicularly to the throughflow direction, such as, for example, the shut-off wedge 2 and the fixed elements, which are not displaced vertically with respect to the throughflow direction. The transition region 13 is in each case displaceable and is displaced corresponding to the shut-off wedge 2. By means of the sealing unit 5 arranged in the transition region, the chamber 6 is sealed and the threaded connection 4 arranged entirely therein is protected from medium and dirt entering the slide space, both when the shut-off valve 11 is open and closed. That is to say, the medium can certainly pass into the slide space 10, but the drive unit 3 protruding through the slide space 10, specifically the threaded connection 4 on the drive unit 3, is no longer openly accessible.

The chamber 4 is at least partially formed by the cavity 8 arranged in the shut-off wedge 2. The cavity is preferably designed as a bore 8 which is closed downwards or ends in a blind hole.

The valve 11 illustrated in FIGS. 1 and 2 shows an embodiment of the slide unit 1 according to the invention in which an internally threaded bore 14 forms the cavity 8 along the interior of the shut-off wedge 2. The external thread 15 arranged at the end of the drive axle 7, which does not move upwards, grips with the internal thread in the shut-off wedge 2, as a result of which the shut-off wedge 2 can be shifted into the open or shut position. It is advantageous if the intermeshing region of the threaded connection 4 is not too long, preferably is configured to be 1 to 4 times the threaded diameter and to have a certain radial play. The shut-off wedge 2 thereby has a certain degree of freedom in the flow direction and centres itself in the sealing seat in the valve housing 12. The sealing unit 5 is arranged at the upper end of the shut-off wedge 2 and is placed in a floating manner on the drive axle 7, that is to say that the sealing unit 5 is displaced along the drive axle 7 as the slide unit 1 is being actuated. The sealing unit 5 is preferably formed in multiple parts and can thereby likewise be adapted to the degree of freedom of the shut-off wedge 2. Preferably, the sealing unit 5 is connected to the shut-off wedge 2, that is to say, if the shut-off wedge 2 is displaced, the sealing unit is correspondingly also displaced with it. It has been shown to be advantageous if the sealing unit 5 is surrounded on the outer side by the shut-off wedge 2, as a result of which the sealing unit 5 is guided axially and radially. In order to arrange the sealing unit 5 as simply as possible on the shut-off wedge 2, a cover 16 ending at the upper end of the shut-off wedge 2 is preferably attached. In the embodiment shown in FIGS. 1 and 2, the drive axle 7 of the drive unit 3 is preferably in the form of a cylindrical shaft which has an external thread at the end, the external thread meshing with the internally threaded bore 14 in the shut-off wedge 2. In this embodiment, the sealed chamber 6 is formed by the internally threaded bore 14 running in the shut-off wedge 2. Said internal thread can either be incorporated directly into the wedge or else formed from the same or a different material by means of an additional insert.

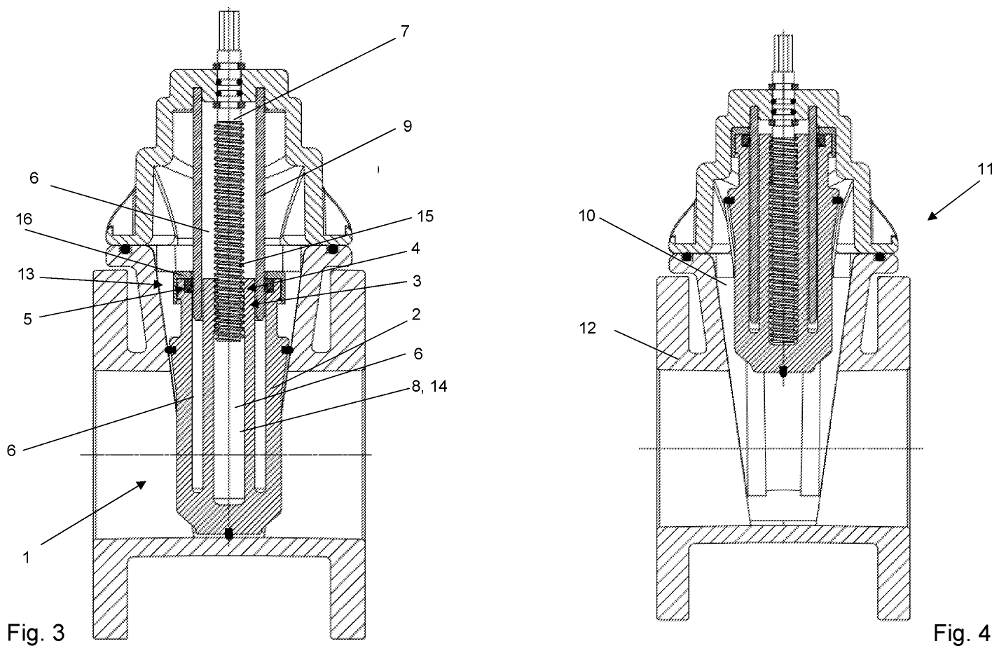

FIGS. 3 and 4 show an alternative embodiment in which one part of the sealed chamber 6 extends in the cavity 8, which runs in the shut-off wedge 2, and another part is formed by the protective sleeve 9 around the drive axle 7. The sealing unit 5 is likewise preferably arranged at the upper end of the shut-off wedge 2 and is correspondingly displaced with it. In this embodiment, the sealing unit 5, which in turn is preferably formed in multiple parts, seals against the protective sleeve 9 which surrounds the drive axle 7. When the shut-off wedge 2 is displaced into the open valve position, the shut-off wedge 2 is displaced over the protective sleeve 9, or the protective sleeve 9 is recessed in the shut-off wedge 2, which has a corresponding groove for receiving the protective sleeve 9. In order also in this embodiment to ensure the degree of freedom of the shut-off wedge 2, a nut 17 with an internal thread is arranged in the shut-off wedge 2, the nut meshing on the drive axle 7, which is in the form of a threaded spindle. As a result, the engaged threaded connection 4 is not longer than 1 to 4 times the threaded diameter. It is readily apparent from FIGS. 3 and 4 that the threaded connection 4 is completely protected by the protective sleeve 9, which forms part of the sealed chamber 6, and the cavity 8 in the shut-off wedge 2. Preferably, in this embodiment, the cavity 8 and the protective sleeve 9 form the sealed chamber 6. Instead of the rigid protective sleeve 9, a telescopic tube or a bellows-like sleeve, which is compressible and extendable in the axial direction, around the drive axle would also be conceivable.

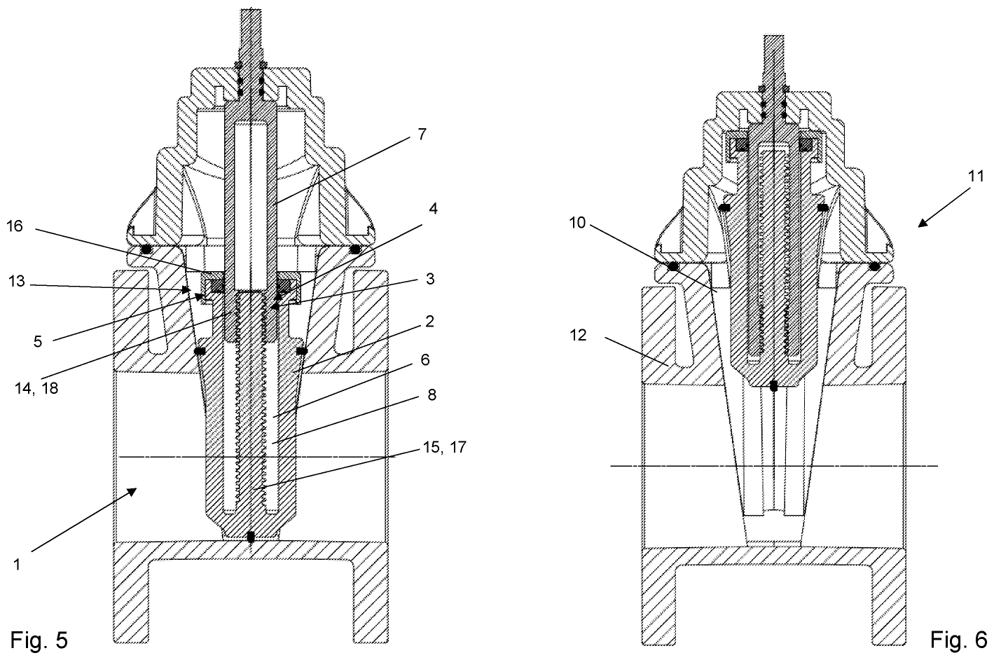

A further embodiment is shown in FIGS. 5 and 6. The threaded connection 4 of the drive unit 3 is formed by a threaded bolt 17 and a threaded nut 18. The threaded bolt 17 is preferably arranged at the closed end of the cavity or the bore 8 in the shut-off wedge 2. The threaded bolt 17 protrudes vertically upwards, and engages in the threaded nut 18, which is arranged in the drive axle 7. The drive axle 7 is preferably in the form of a tube or, at least at the lower end, has a cavity which extends in the drive axle 7 and in which the threaded bolt 17 is displaced during the movement of the shut-off wedge 2. It is advantageous if the threaded nut 18 is arranged nondisplaceably at the lower end of the drive axle 7. When the hollow or partially hollow drive axle 7, which is configured in a manner such that it does not move upwards, is actuated, the threaded bolt 17 is displaced vertically and therefore so too is the shut-off wedge 2, which is fixedly connected to the threaded bolt 17. A sealing element 5 is arranged at the upper end of the shut-off wedge 2, the sealing element being axially fixedly connected to the shut-off wedge 2 and being arranged in a floating manner on the drive axle 7 and thus is displaced as the shut-off wedge 2 is actuated, and seals against the drive axle 7. The sealed chamber 6 is formed by the cavity or the bore in the shut-off wedge 2, which cavity is sealed by the sealing unit 5 at the upper end of the shut-off wedge on the drive axle 7.

What is claimed is:

1. A slide unit for a shut-off valve, preferably a gate valve, comprising a shut-off wedge for closing and opening the shut-off valve and a drive unit having a threaded connection for actuating the shut-off wedge, wherein the slide unit has a sealed chamber, wherein the threaded connection of the drive unit is arranged in the sealed chamber and a sealing unit is provided for sealing the chamber, as a result of which the entire threaded connection is constantly protected against the medium and contaminants, both when the shut-off valve is open and closed.

2. A slide unit according to claim 1, wherein the sealed chamber is at least partially formed by a cavity extending in the shut-off wedge, preferably a bore.

3. A slide unit according to claim 1, wherein the cavity in the shut-off wedge is closed downwards, or does not run all the way through the latter.

4. A slide unit according to claim 1, wherein the sealed chamber is sealed by means of the sealing unit and the sealing unit is arranged in a floating manner.

5. A slide unit according to claim 1, the sealing unit is arranged and fixed at the upper end of the shut-off wedge and the sealing unit is displaced as the shut-off wedge is displaced.

6. A slide unit according to claim 1, wherein the drive unit has a drive axle, which does not move upwards, upon the actuation of which the shut-off wedge moves upwards or downwards in order to open or close the shut-off valve.

7. A slide unit according to claim 1, wherein the threaded connection is formed by an internal thread arranged in the cavity of the shut-off wedge and an external thread arranged on the drive axle or an internal thread arranged in the drive axle and an external thread arranged in the cavity of the shut-off wedge.

8. A slide unit according to claim 1, wherein the sealing unit is arranged in a displaceable or floating manner on the drive axle.

9. A slide unit according to claim 1, wherein the sealed chamber surrounds the threaded connection of the drive unit.

10. A slide unit according to claim 1, the sealing unit is arranged in the transition region.

11. A slide unit according to claim 1, the sealed chamber is formed by a cavity extending in the shut-off wedge, preferably a bore.

12. A slide unit according to claim 1, a protective sleeve is arranged around the drive axle.

13. A slide unit according to claim 1, the drive axle has an external or internal thread.

14. A slide unit according to claim 1, the drive axle is at least partially hollow.
